(19) United States
(12) Patent Application Publication
(10) Pub. No.: US 2021/0133093 A1
(43) Pub. Date: May 6, 2021

(54) DATA ACCESS METHOD, PROCESSOR, COMPUTER SYSTEM, AND MOBILE DEVICE

(71) Applicant: SZ DJI TECHNOLOGY CO., LTD., Shenzhen (CN)

(72) Inventors: Kang YANG, Shenzhen (CN); Peng LI, Shenzhen (CN); Feng HAN, Shenzhen (CN)

(73) Assignee: SZ DJI TECHNOLOGY CO., LTD., Shenzhen (CN)

(21) Appl. No.: 17/120,467

(22) Filed: Dec. 14, 2020

Related U.S. Application Data
(63) Continuation of application No. PCT/CN2018/096904, filed on Jul. 24, 2018.

(51) Int. Cl. G06F 12/02; G06F 12/0891; G06F 12/14; G06N 3/08; G06F 9/30

(52) U.S. Cl. CPC G06F 12/0207; G06F 12/0891; G06F 9/30138; G06N 3/08; G06F 12/1483

(57) ABSTRACT

A processor includes a computation array and a cache array, and a bit width of each cache in the cache array is equal to a bit width of a data unit processed by the computation array. A data access method includes: reading M*N data units from a memory to N input caches in the cache array with a first access bit width, where the first access bit width is N times a bit width of each cache, data units in one column of the M*N data units are stored in one of the N input caches, and M and N are positive integers greater than 1; and reading the data units in the N input caches to the computation array with a second access bit width, where the second access bit width is the bit width of each cache.

### RELATED DISCLOSURES

This application is a continuation disclosure of PCT disclosure No. PCT/CN2018/096904, filed on Jul. 24, 2018, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of information technologies, and more specifically, to a data access method, a processor, a computer system, and a mobile device.

### BACKGROUND

With the development of the Internet and semiconductor technologies, the reliability of a deep learning algorithm in some application fields in recent years has reached the threshold for commercially applying the deep learning algorithm. However, because a huge amount of computation is required, the application of deep learning is limited to some extent. Therefore, design of a processor dedicated to deep learning is of vital importance.

Currently, the deep learning algorithm that is applied most extensively is a convolutional neural network (Convolutional Neural Network, CNN). Approximately 90% of its computation is convolutional operations. An important objective of the design of a processor chip dedicated to deep learning is to provide high-performance convolutional computation.

To achieve high-performance operation, on one hand, a large computation array is required; on the other hand, highly-efficient data access is also critical. Therefore, how to improve the efficiency of data access becomes a technical problem to be urgently resolved in processor design.

### SUMMARY

Embodiments of the present disclosure provide a data access method, a processor, a computer system, and a mobile device.

In a first aspect, some exemplary embodiments of the present disclosure provide a data access method for a processor, the processor including a computation array and a cache array, a bit width of each cache in the cache array being equal to a bit width of a data unit processed by the computation array, the method includes: reading M*N data units from a memory to N input caches in the cache array based on a first access bit width, wherein the first access bit width is N times a bit width of each cache, data units in one column of the M*N data units are stored in one of the N input caches, and M and N are positive integers greater than 1; and reading the data units in the N input caches to the computation array based on a second access bit width, wherein the second access bit width is the bit width of each cache.

In a second aspect, some exemplary embodiments of the present disclosure provide a processor including a computation array and a cache array, wherein a bit width of each cache in the cache array is equal to a bit width of a data unit processed by the computation array, the cache array is configured to read M*N data units from a memory to N input caches in the cache array based on a first access bit width, the first access bit width is N times a bit width of each cache, data units in one column of the M*N data units are stored in one of the N input caches, and M and N are positive integers greater than 1, the computation array is configured to read the data units in the N input caches to the computation array based on a second access bit width, and the second access bit width is the bit width of each cache.

In a third aspect, some exemplary embodiments of the present disclosure provide a computer system, including a memory configured to store a computer-executable instruction; and a processor configured to access the memory, and execute the computer-executable instruction to perform operations of the data access method as set forth in the first aspect.

In a fourth aspect, some exemplary embodiments of the present disclosure provide a mobile device as set forth in the second aspect, or a computer system as set forth in the third system.

In the technical solutions of some exemplary embodiment of this disclosure, the cache array whose bit width is equal to the bit width of the data unit processed by the computation array is used as an intermediate cache for performing data access. The required cache array has a low bit width, occupies few resources, can adapt to data access required by the computation array, and can improve the efficiency of data access.

### BRIEF DESCRIPTION OF THE DRAWINGS

FIG. 1a is a schematic diagram of a data processing procedure of a convolutional neural network according to some exemplary embodiments of the present disclosure;

FIG. 1b is a schematic diagram of a data input format of a MAC computation array according to some exemplary embodiments of the present disclosure;

FIG. 2 and FIG. 3 are architectural diagrams of technical solutions to which some exemplary embodiments of this disclosure are applied;

FIG. 4 is an exemplary structural diagram of a MAC computation array according to some exemplary embodiments of this disclosure;

FIG. 5 is a schematic architectural diagram of a mobile device according to some exemplary embodiments of this disclosure;

FIG. 6 is a schematic flowchart of a data access method according to some exemplary embodiments of this disclosure;

FIG. 7 is a schematic diagram of a data input process according to some exemplary embodiments of this disclosure;

FIG. 8 is a schematic diagram of a data output process according to some exemplary embodiments of this disclosure;

FIG. 9 is a schematic block diagram of a processor according to some exemplary embodiments of this disclosure; and

FIG. 10 is a schematic block diagram of a computer system according to some exemplary embodiments of this disclosure.

### DETAILED DESCRIPTION

The following describes the technical solutions in some exemplary embodiments of this disclosure with reference to accompanying drawings.

It should be understood that specific examples in this specification are only intended to help a person skilled in the art better understand the embodiments of this disclosure, instead of limiting the scope of the embodiments of this disclosure.

It should also be understood that sequence numbers of processes do not mean execution sequences in various embodiments of this disclosure. The execution sequences of the processes should be determined based on functions and internal logic of the processes, and should not be construed as any limitation on implementation processes of the embodiments of this disclosure.

It should also be understood that various embodiments described in this specification may be implemented independently or implemented in combination. This is not limited in the embodiments of this disclosure.

The technical solutions of the embodiments of this disclosure may be applied to various deep learning algorithms, for example, a convolutional neural network. This is not limited in the embodiments of this disclosure.

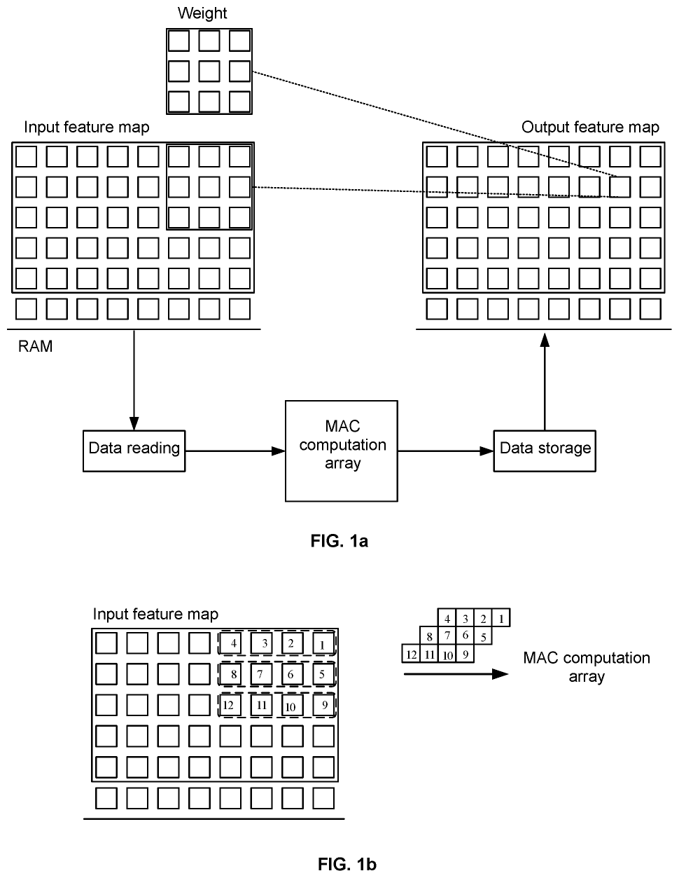

FIG. 1a is a schematic diagram of a data processing procedure of a convolutional neural network.

As shown in FIG. 1a, the processing procedure of the convolutional neural network is to perform inner product operations on input eigenvalues in a window in an input feature map (Input Feature Map, IF) and weights in a multiply accumulate (MAC) computation array, and output obtained results to an output feature map (OF). The input feature map and the output feature map (collectively referred to as a feature map) are generally stored in a memory, for example, a random access memory (RAM). In the exemplary embodiment of this disclosure, data access means “reading” data from the RAM to the MAC computation array and “storing” data from the MAC computation array to the RAM after the computation of the MAC computation array is completed.

The feature map is generally stored continuously in segments in the RAM, but the MAC computation array requires “interleaved” inputting/outputting among a plurality of feature maps or a plurality of rows of data for high efficiency of computation. For example, as shown in FIG. 1b, the MAC computation array requires data units 1 to 12 to enter the MAC computation array in a sequence of {1}, {2, 5}, {3, 6, 9}, {4, 7, 10}, {8, 11}, and {12}. In some exemplary embodiments, to resolve this conflict between “storage” and “computation” (usage), an intermediate storage medium, for example, a cache array may be used to implement format conversion.

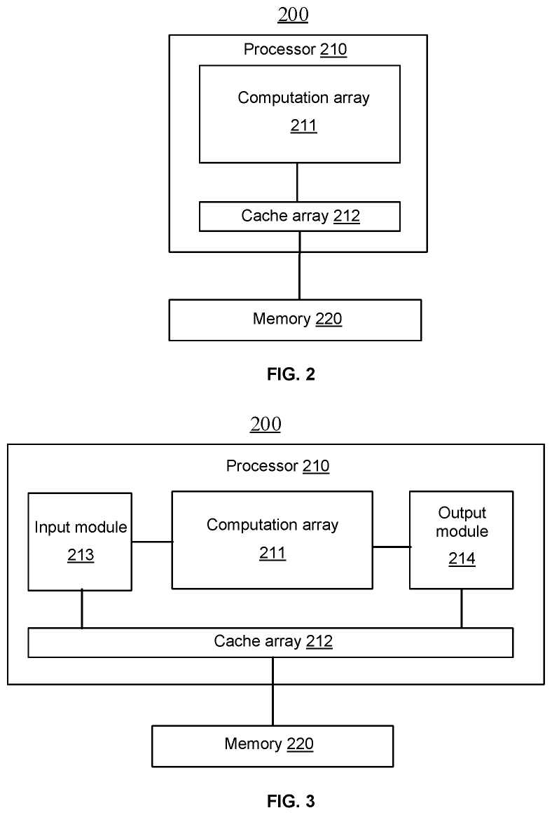

FIG. 2 is an architectural diagram of a technical solution to which some exemplary embodiments of this disclosure is applied.

As shown in FIG. 2, a system 200 may include a processor 210 and a memory 220.

The memory 220 is configured to store to-be-processed data, for example, an input feature map, and store data processed by the processor, for example, an output feature map. The memory 220 may be the aforementioned RAM, for example, a static random access memory (SRAM).

The processor 210 is configured to read data from the memory 220 to perform processing, and store the processed data to the memory 220. The processor 210 may include a computation array 211 and a cache array 212. Based on such a design, during data inputting, data is first read from the memory 220 to the cache array 212, and the computation array 211 then reads, from the cache array 212, data required for computation; during data outputting, the computation array 211 first outputs the data to the cache array 212, and then the data is stored from the cache array 212 to the memory 220. The cache array 212, as an intermediate storage medium, may implement conversion between various data access formats, to satisfy a requirement for inputting/outputting data by the computation array 211, for example, a data input format shown in FIG. 1b.

In some exemplary embodiments, the computation array 211 may input and output data through corresponding input and output modules. For example, as shown in FIG. 3, the processor 210 may further include an input module 213 and an output module 214. The computation array 211 may read, from the cache array 212, the data required for computation through the input module 213, and outputs the data to the cache array 212 through the output module 214. For example, the input module 213 may be a network on chip. In this case, the network on chip implements data reading through a corresponding bus design. The output module 214 may be a partial sum memory configured to temporarily store an intermediate result in the computation array 211, resend the intermediate result to the computation array 211 for accumulation, and forward a final computation result obtained by the computation array 211 to the cache array 212. When there is no intermediate result, the partial sum memory may be configured to only forward the final computation result of the computation array 211.

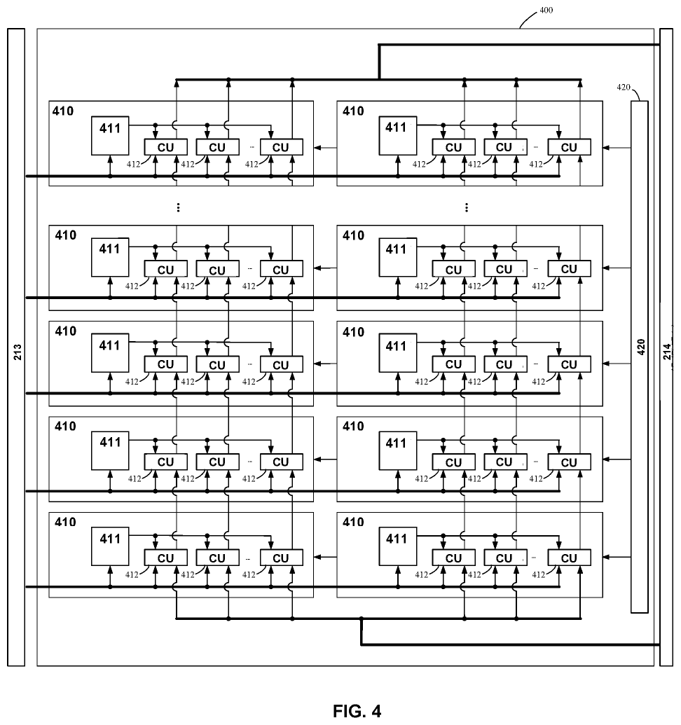

In some exemplary embodiments, the computation array 211 is a MAC computation array. FIG. 4 is an exemplary structural diagram of a MAC computation array. As shown in FIG. 4, the MAC computation array 400 may include a two-dimensional array of a MAC computation group 410 and a MAC control module 420. The MAC computation group 410 may include a weight register 411 and a plurality of MAC computation units (CUs) 412. The MAC computation unit (CU) 412 is configured to temporarily store an input eigenvalue, and perform a multiply-accumulate operation on the temporarily stored input eigenvalue and a filter weight temporarily stored in the weight register 411.

In some embodiments, the system 200 may be disposed in a mobile device. The mobile device may be an unmanned aerial vehicle, an unmanned surface vehicle, a self-driving vehicle, a robot, or the like, and is not limited in this exemplary embodiment of this disclosure.

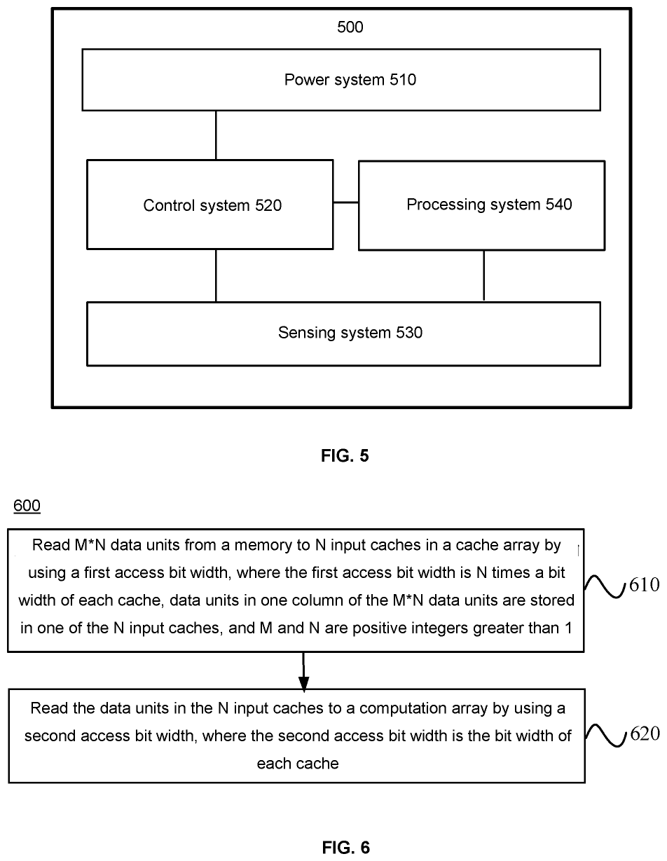

FIG. 5 is a schematic architectural diagram of a mobile device 500 according to some exemplary embodiments of this disclosure.

As shown in FIG. 5, the mobile device 500 may include a power system 510, a control system 520, a sensing system 530, and a processing system 540.

The power system 510 is configured to provide power for the mobile device 500.

Taking an unmanned aerial vehicle as an example, a power system of the unmanned aerial vehicle may include an electronic speed adjustor, a propeller(s), and a motor(s) corresponding to the propeller(s). The motor is connected between the electronic speed adjustor and the propeller. The motor and the propeller are disposed on a corresponding arm. The electronic speed adjustor is configured to receive a drive signal generated by the control system, and then provide a drive current for the motor based on the drive signal, to control a rotation speed of the motor. The motor is configured to drive the propeller to rotate, thereby providing a flight power to the unmanned aerial vehicle.

The sensing system 530 may be configured to measure posture information of the mobile device 500, that is, location information and status information of the mobile device 500 in space, for example, a three-dimensional location, a three-dimensional angle, a three-dimensional speed, three-dimensional acceleration, a three-dimensional angular speed, or the like. The sensing system 530 may include, for example, at least one of sensors such as a gyroscope, an electronic compass, an inertial measurement unit (IMU), a vision sensor, a global positioning system (GPS), a barometer, and an airspeed meter.

The sensing system 530 may be further configured to capture an image. To be specific, the sensing system 530 may include a sensor configured to capture an image, for example, a camera.

The control system 520 is configured to control movements of the mobile device 500. The control system 520 may control the mobile device 500 based on a preset program instruction. For example, the control system 520 may control movements of the mobile device 500 based on the posture information of the mobile device 500 that is measured by the sensing system 530. The control system 520 may also control the mobile device 500 based on a control signal from a remote control. For example, for the unmanned aerial vehicle, the control system 520 may be a flight control system (flight control), or a control circuit in a flight control.

The processing system 540 may process an image(s) captured by the sensing system 530. For example, the processing system 540 may be an image signal processing (ISP) chip, or the like.

The processing system 540 may be the system 200 in FIG. 2, or the processing system 540 may include the system 200 in FIG. 2.

It should be understood that division and naming of components of the mobile device 500 are merely exemplary, and should not be understood as limitations on this exemplary embodiment of this disclosure.

It should also be understood that the mobile device 500 may further include other components not shown in FIG. 5. This is not limited in this exemplary embodiment of this disclosure.

For the design of an intermediate storage medium, an implementation is to adopt a first input first output (FIFO) queue having a large bit width, where the bit width of the FIFO queue is the bit width of a plurality of columns of data for “interleaved” inputting and outputting, for example, the bit width of four columns of data as shown in FIG. 1b. However, using the FIFO queue having a large bit width as an intermediate cache for data inputting and outputting of a computation array may waste large storage space. This may indirectly increases the area (cost) of a chip, as well as the power consumption, affect the efficiency of data access, and thus is disadvantageous to an application to a platform having a high requirement on hardware resources, for example, a mobile device.

In view of this, some exemplary embodiments of this disclosure provides a technical solution to improve the efficiency of data access by improving the design of an intermediate storage medium. The following describes the technical solution in this exemplary embodiment of this disclosure in detail.

FIG. 6 is a schematic flowchart of a data access method 600 according to some exemplary embodiments of this disclosure. The method 600 may be performed by a processor. The processor includes a computation array and a cache array, and a bit width of each cache in the cache array is equal to a bit width of a data unit processed by the computation array.

As shown in FIG. 6, the method 600 includes the following steps.

610. Read M*N data units from a memory to N input caches in the cache array based on a first access bit width, where the first access bit width is N times a bit width of each cache, data units in one column of the M*N data units are stored in one of the N input caches, and M and N are positive integers greater than 1.

620. Read the data units in the N input caches to the computation array based on a second access bit width, where the second access bit width is the bit width of each cache.

In this exemplary embodiment of this disclosure, the bit width of each cache in the cache array used as an intermediate storage medium is equal to a bit width of a data unit processed by the computation array. For example, the bit width of the cache may be a bit width of an eigenvalue in an input feature map.

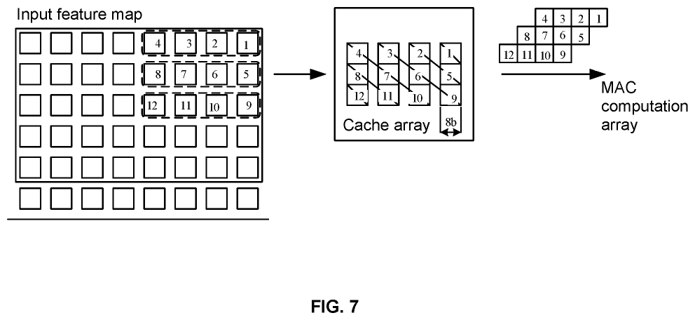

As shown in FIG. 7, if a bit width of an eigenvalue in an input feature map is 8b (8 bits), a cache array in which the bit width of each cache is 8b may be used.

In some exemplary embodiments, the cache array may be a RAM array, a FIFO array, a register (REG) array, or the like, and is not limited in this exemplary embodiment of the present disclosure.

In a process of reading data from the memory to the cache array, N data units may be read at a time, and stored to N input caches. To be specific, data is read based on the first access bit width that is N times the bit width of the cache; M*N data units are read from the memory to N input caches; and data units in one column of the M*N data units are stored in one of the N input caches.

For example, as shown in FIG. 7, to facilitate interleaved inputting of data into a MAC computation array, 3*4 data units may be read to four input caches based on a 32b access bit width.

In a process of reading data from the cache array to the computation array, a data unit may be read from each cache based on the bit width of the cache (the second access bit width), so as to satisfy a requirement for processing by the computation array.

In some exemplary embodiments, the data units in the N input caches may be read to the computation array based on the second access bit width according to a processing sequence of the computation array.

For example, for a convolutional neural network, the data units are eigenvalues in a feature map, and the processing sequence is a processing sequence in the convolutional neural network.

For example, as shown in FIG. 7, based on the processing sequence of the MAC computation array, data units 1 to 12 need to enter the MAC computation array in a sequence of {1}, {2, 5}, {3, 6, 9}, {4, 7, 10}, {8, 11}, and {12}. Because the bit width of the cache is equal to the bit width of the data unit, and the MAC computation array may read one data unit every time based on the access bit width of the cache, data units required for computation may be read based on the foregoing sequence.

A computation result may be output in a manner corresponding to that of inputting. The data units processed by the computation array may be first stored to N output caches in the cache array based on the second access bit width; and the M*N data units in the N output caches are stored to the memory based on the first access bit width.

To be specific, in a process of outputting data from the computation array to the cache array, a data unit may be output by using the access bit width of the cache and based on a granularity of a data unit; and in a process of outputting data from the cache array to the memory, N data units in a same output feature map may be output to a corresponding output feature map at a time by using the first access bit width that is N times the bit width of the cache.

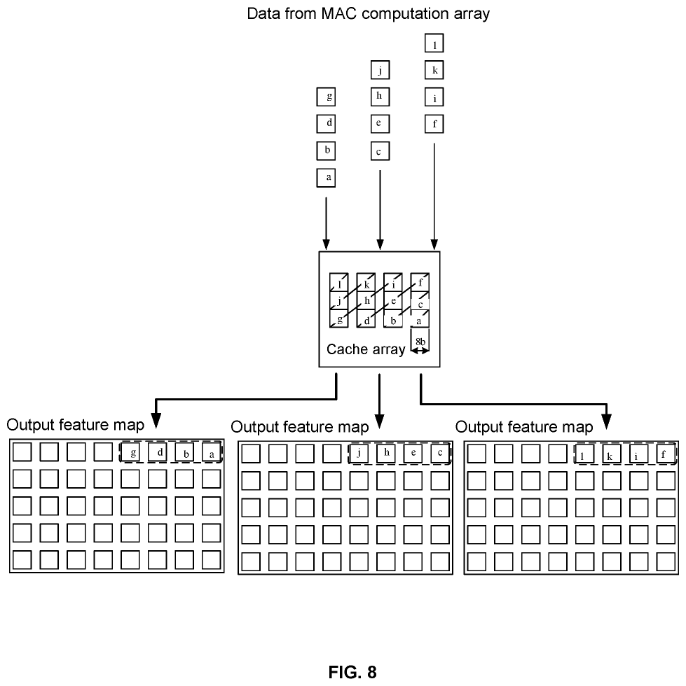

For example, as shown in FIG. 8, for data units a to I, each data unit may be first stored to a corresponding position in 4 output caches based on a granularity of a data unit (the second access bit width), and then data units in a same output feature map are stored to a corresponding output feature map in the memory based on a granularity of 4 data units (the first access bit width).

It should be understood that when the processor is an on-chip component, the memory may be an on-chip memory or an off-chip memory. The processor may further include the memory.

In the technical solution of this exemplary embodiment of this disclosure, the cache array whose bit width is equal to the bit width of the data unit processed by the computation array is used as an intermediate cache for performing data access. The required cache array has a low bit width, occupies few resources, can adapt to data access required by the computation array, and can improve the efficiency of data access.

The foregoing describes the data access method in this exemplary embodiment of this disclosure in detail. The following will describe a processor, a computer system, and a mobile device in some exemplary embodiments of this disclosure. It should be understood that the processor, the computer system, and the mobile device in the embodiments of this disclosure may perform the methods in the foregoing exemplary embodiments of this disclosure. To be specific, for a detailed working process of each of the following products, refer to the corresponding process in the foregoing method embodiment.

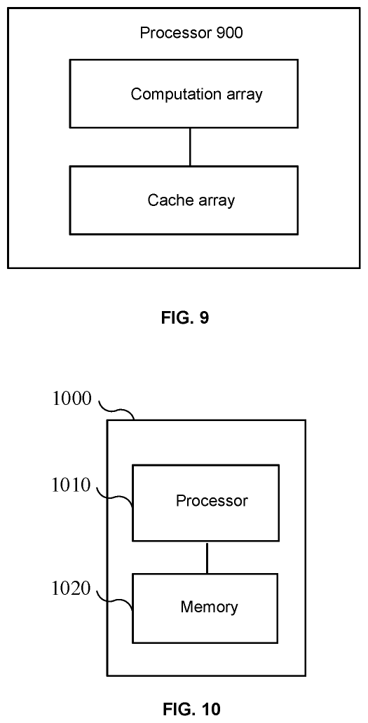

FIG. 9 is a schematic block diagram of a processor 900 in this disclosure.

As shown in FIG. 9, the processor 900 may include a computation array 910 and a cache array 920.

A bit width of each cache in the cache array 920 is equal to a bit width of a data unit processed by the computation array 910.

The cache array 920 is configured to read M*N data units from a memory to N input caches in the cache array 920 based on a first access bit width, where the first access bit width is N times a bit width of each cache, data units in one column of the M*N data units are stored in one of the N input caches, and M and N are positive integers greater than 1.

The computation array 910 is configured to read the data units from the N input caches to the computation array 910 based on a second access bit width, where the second access bit width is the bit width of each cache.

In some exemplary embodiments, the computation array 910 is configured to read the data units from the N input caches to the computation array based on the second access bit width and according to a processing sequence of the computation array 910.

In some exemplary embodiments, the data units are eigenvalues in a feature map, and the processing sequence is a processing sequence in a convolutional neural network.

In some exemplary embodiments, the computation array 910 is further configured to store the data units processed by the computation array 910 to N output caches in the cache array 920 based on the second access bit width.

The cache array 920 is further configured to store the M*N data units in the N output caches to the memory based on the first access bit width.

In some exemplary embodiments, the cache array 920 is a random access memory RAM array, a first in first out (FIFO) array, or a register REG array.

In some exemplary embodiments, the processor is an on-chip component, and the memory is an on-chip memory or an off-chip memory.

In some exemplary embodiments, the computation array 910 is a multiply-accumulate MAC computation array.

In some exemplary embodiments, the processor 900 further includes the memory.

It should be understood that the processor in the foregoing exemplary embodiments of this disclosure may be a chip, and may be specifically implemented by a circuit. However, a specific implementation is not limited in this exemplary embodiment.

FIG. 10 is a schematic block diagram of a computer system 1000 according to some exemplary embodiments of this disclosure.

As shown in FIG. 10, the computer system 1000 may include a processor 1010 and a memory 1020.

It should be understood that the computer system 1000 may further include other components that are generally included in a computer system, for example, an input/output device and a communication interface. This is not limited in this exemplary embodiment.

The memory 1020 is configured to store a computer-executable instruction(s).

The memory 1020 may be memories of various types, for example, may be a high-speed random access memory (RAM), and may further include a non-volatile memory, for example, disk storage. This is not limited in this exemplary embodiment.

The processor 1010 is configured to access the memory 1020, and execute the computer-executable instruction to perform operations in the data access method in the foregoing embodiment of this disclosure.

The processor 1010 may include a microprocessor, a field-programmable gate array (FPGA), a central processing unit (CPU), a graphics processing unit (GPU), or the like. This is not limited in this exemplary embodiment.

Some exemplary embodiments of this disclosure further provide a mobile device, where the mobile device may include the processor or computer system in the foregoing embodiments of this disclosure.

The processor, computer system, and mobile device in the embodiments of this disclosure may correspond to entities that perform the data access method in the embodiments of this disclosure, and the foregoing and/or other operations and/or functions of modules in the processor, the computer system, and the mobile device are respectively intended to implement corresponding procedures in each method. For brevity, details will not be described herein.

Some exemplary embodiments of this disclosure further provide a computer storage medium, where program code is stored in the computer storage medium, and the program code may be used to instruct performing the data access method in the foregoing embodiments of this disclosure.

It should be understood that the term “and/or” in the embodiments of this disclosure describes only an association relationship between associated objects and represents that three relationships may exist. For example, A and/or B may represent the following three cases: only A exists, both A and B exists, and only B exists. In addition, the character “/” in this specification generally indicates an “or” relationship between the associated objects.

A person of ordinary skill in the art may be aware that, with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the several embodiments provided in this disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or may not be performed. In addition, the mutual couplings or direct couplings or communication connections shown or discussed herein may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network elements. Some or all of the units may be selected based on actual requirements to achieve the objectives of the solutions of the embodiments of this disclosure.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this disclosure essentially, or the part contributing to the prior art, or an entirety or a part of the technical solutions may be implemented in the form of a software product. The computer software product is stored in a storage medium and includes several instructions for instructing a computer device (which may be a personal computer, a server, a network device, or the like) to perform all or a part of the steps of the methods described in the embodiments of this disclosure. The foregoing storage medium includes any medium that can store program code, such as a USB flash drive, a removable hard disk, a read-only memory (ROM), a random access memory (RAM), a magnetic disk, or an optical disc.

The foregoing descriptions are merely some specific exemplary embodiments of this disclosure, and are not intended to limit the scope of protection of this disclosure. Any modification or replacement readily figured out by a person skilled in the art within the technical scope disclosed in this disclosure shall fall within the scope of protection of this disclosure. Therefore, the scope of protection of this disclosure shall be subject to the scope of protection defined in the appended claims.

What is claimed is:

1. A data access method for a processor, wherein the processor includes a computation array and a cache array, a bit width of each cache in the cache array is equal to a bit width of a data unit processed by the computation array,
the method comprising:
reading M*N data units from a memory to N input caches in the cache array with a first access bit width, wherein
the first access bit width is N times of the bit width of each cache,
data units in each column of the M*N data units are stored together in one corresponding input cache of the N input caches, and
M and N are positive integers greater than 1; and
reading the data units in the N input caches to the computation array with the second access bit width, wherein the second access bit width is equal to the bit width of each cache.

2. The method according to claim 1, wherein the reading of the data units in the N input caches to the computation array with the second access bit width includes:
reading the data units in the N input caches to the computation array with the second access bit width according to a processing sequence of the computation array.

3. The method according to claim 2, wherein the data units are eigenvalues in a feature map, and
the processing sequence is a processing sequence in a convolutional neural network.

4. The method according to claim 1, further comprising:
storing the data units processed by the computation array to N output caches in the cache array with the second access bit width; and
storing the M*N data units from the N output caches to the memory with the first access bit width.

5. The method according to claim 1, wherein the cache array is a random access memory (RAM) array, a first in first out (FIFO) array, or a register (REG) array.

6. The method according to claim 1, wherein the processor is an on-chip component, and the memory is an on-chip memory or an off-chip memory.

7. The method according to claim 1, wherein the computation array is a multiply-accumulate (MAC) computation array.

8. The method according to claim 1, wherein the processor further includes the memory.

9. A processor, comprising:
a computation array; and
a cache array,
wherein a bit width of each cache in the cache array is equal to a bit width of a data unit processed by the computation array,
the cache array is configured to read M*N data units from a memory to N input caches in the cache array with a first access bit width, wherein the first access bit width is N times of the bit width of each cache, data units in each column of the M*N data units are stored together in one corresponding input cache of the N input caches, and M and N are positive integers greater than 1, and
the computation array is configured to read the data units in the N input caches to the computation array with the second access bit width, wherein the second access bit width is equal to the bit width of each cache.

10. The processor according to claim 9, wherein the computation array is configured to read the data units in the N input caches to the computation array with the second access bit width according to a processing sequence of the computation array.

11. The processor according to claim 10, wherein the data units are eigenvalues in a feature map, and the processing sequence is a processing sequence in a convolutional neural network.

12. The processor according to claim 9, wherein the computation array is further configured to store the data units processed by the computation array to N output caches in the cache array with the second access bit width; and
the cache array is further configured to store the M*N data units in the N output caches to the memory with the first access bit width.

13. The processor according to claim 9, wherein the cache array is a random access memory (RAM) array, a first in first out (FIFO) array, or a register (REG) array.

14. The processor according to claim 9, wherein the processor is an on-chip component, and the memory is an on-chip memory or an off-chip memory.

15. The processor according to claim 9, wherein the computation array is a multiply-accumulate (MAC) computation array.

16. The processor according to claim 9, wherein the processor further includes the memory.

17. A mobile device, comprising:
a processor or a computer system;
the processor includes a computation array and a cache array;
wherein a bit width of each cache in the cache array is equal to a bit width of a data unit processed by the computation array,
the cache array is configured to read M*N data units from a memory to N input caches in the cache array with a first access bit width, wherein the first access bit width is N times of the bit width of each cache, data units in each column of the M*N data units are stored together in one corresponding input cache of the N input caches, and M and N are positive integers greater than 1, and
the computation array is configured to read the data units in the N input caches to the computation array with the second access bit width, wherein the second access bit width is equal to the bit width of each cache.

18. The mobile device according to claim 19, wherein the computer system includes a memory configured to store a computer-executable instruction; and the processor configured to access the memory.
